(19) United States
(12) Patent Application Publication
(10) Pub. No.: US 2003/0021119 A1
(43) Pub. Date: Jan. 30, 2003

(54) Elliptical headlamp equipped with masks having transverse pivoting axes

(76) Inventors: Eric Blusseau, Bobigny Cedex (FR); Joel Leleve, Bobigny Cedex (FR)

Correspondence Address: MORGAN & FINNEGAN, L.L.P., 345 PARK AVENUE, NEW YORK, NY, 10154, US

(21) Appl. No.: 10/202,194

(22) Filed: Jul. 23, 2002

(30) Foreign Application Priority Data
Jul. 26, 2001 (FR) 0110288

(51) Int. Cl. F21V 1/00

(52) U.S. Cl. 362/277

(57) ABSTRACT

The invention proposes a headlamp comprising a light source, a reflector of the elliptical type, and a converging lens, of the type in which a first mask is mounted for pivoting about a substantially transverse axis and includes a cut-off edge which, in the shading position, delimits a cut-off profile of the light beam given off by the source with a view to carrying out a first lighting function, a second mask being mounted for pivoting about a substantially transverse axis, and each of the two masks being able to be controlled and used independently in such a way that, depending on their relative position, at least three distinct lighting functions are carried out. According to the invention, each mask is in the shape of a plate, more particularly a rectangular plate, including two substantially transverse and horizontal edges, and the pivot axis of each mask is along one of its transverse edges.

### FIELD OF THE INVENTION

The present invention relates to a headlamp of the elliptical type for a motor vehicle.

The present invention relates more particularly to a headlamp for a motor vehicle, comprising a light source, a reflector of the elliptical type, a first focus of which is situated in the vicinity of the source, a converging lens a focal plane of which passes in the vicinity of a second focus of the reflector, a first and a second mask which are interposed axially, along the optical axis of the headlamp, between the reflector and the lens, of the type in which the first mask is mounted pivoting about a substantially transverse axis between a retracted position and a shading position, the first mask including a cut-off edge which, in the shading position, delimits a cut-off profile of the light beam given off by the source with a view to carrying out a first lighting function, and of the type in which the second mask is mounted movable between a protracted position and a shading position which makes it possible to carry out at least one second lighting function by modifying the cut-off profile of the light beam, the second mask being mounted for pivoting about a substantially transverse axis, and each of the two masks being able to be controlled and used independently in such a way that, depending on their relative position, at least three distinct lighting functions are carried out.

### BACKGROUND OF THE INVENTION

When such a headlamp has to form a cut-off beam, such as a dipped beam or a fog lamp beam, it includes a mask interposed axially between the light source and the lens, which shades the part of the radiation which otherwise would propagate beyond this cut-off.

In such a type of headlamp, it is then difficult to modify the profile of the cut-off. Such a modification has to be envisaged especially when a headlamp, designed, for example, for traffic driving on the right, has to form a light beam, cut-off, adapted for traffic driving on the left.

Such a modification of the cut-off profile also has to be envisaged when it is desired to implement improved lighting facilities.

In fact, in the field of vehicle lighting, it is sought to develop new facilities with a view to enhancing the quality of the lighting provided by the vehicle headlamps, especially under certain specific traffic conditions, for example when the vehicle is driving in town, or when it is driving in wet weather, or when it is driving on the motorway. These new lighting functions are generally grouped together under the title of AFS functions, AFS standing for “Advanced Front Lighting System”.

One known solution for modifying the profile of the cut-off consists in taking action on the mask of the headlamp so as to modify its cut-off profile.

An elliptical headlamp is known, from the document EP-A-0.381.851, of the type including a first mask provided between the reflector and the lens, which features an edge defining a first particular cut-off profile for the light beam given off, and a second mask arranged on the first mask and movable selectively between two positions, a first position in which one edge of the second mask is positioned on the path of the light rays so as, with the first mask, to form a light beam with a second particular cut-off profile, and a second position in which the said edge of the second mask is positioned substantially out of the path of the light rays so as to form a light beam with the first cut-off profile.

Moreover, a solution for selectively implementing a dipped function or a main-beam function consists in making the movable mask of the headlamp pivot so as to position it respectively in or out of the light beam given off.

On that subject, a headlamp of the elliptical type is already known, the headlamp including a mask pivoting between a dipped-beam position and a main-beam position, about an axis which is generally horizontal and parallel to the optical axis.

The mask is mounted so as to pivot on a framework part of the headlamp, in the region of one of its lateral sides, and the pivoting movement of the mask is performed in such a way that it always remains in the vertical plane transverse to the optical axis in which it is in the dipped-beam position.

Such a headlamp exhibits several drawbacks.

First of all, with such a mask arrangement pivoting about an axis parallel to the optical axis, having regard to the lack of space available in the housing of the headlamp, below the mask, it is impossible to completely clear the mask from the light beam given off, at the side where the axis of pivoting of the said mask is located.

Thus, when this headlamp is operating in main-beam mode, the light beam given off features a reduced brightness due to the fact that part of the mask, situated on the same side as the axis of pivoting of the latter, always remains on the path of the light rays given off.

Moreover, the mounting of the mask so that it can pivot on one of its lateral sides gives rise to inadequate balancing of the mask, which is not supported on the other side.

Finally, such a pivoting-mask arrangement requires the use of a bulky and powerful activating means in order to ensure the return of the mask, in the main-beam position, to the dipped-beam position with the desired rapidity.

In order to solve these problems, the document FR-A-2.796.449 proposes a headlamp of the elliptical type which includes a main mask mounted pivoting about a transverse axis and which includes a secondary mask mounted pivoting about an axis parallel to the optical axis.

When the main mask is in shading position, that is to say in a transverse plane, and when the secondary mask is in a downwards-retracted position, the headlamp produces a lighting beam with a first cut-off profile.

When the secondary mask is caused to pivot to its upper shading position, the main mask occupying its shading position, then the headlamp produces a lighting beam with a second cut-off profile different from the first one.

This type of headlamp is not completely satisfactory.

This is because the secondary mask is designed to modify the cut-off produced by the main mask in the lighting beam by increasing the shaded surface.

Consequently, the secondary beam does not make it possible to produce a lighting beam which exhibits a specific cut-off profile including a lighting area less shaded with respect to the first cut-off profile.

Moreover, with the secondary mask being of small dimensions, the thermal stresses to which the inside of the headlamp is subjected can modify its geometry and cause malfunctions of the headlamp.

The thermal stresses mentioned above also make it difficult to index the various positions of the secondary mask.

Moreover, the main-beam function is difficult to achieve by reason of the proximity of the axis of pivoting of the secondary mask to the upper part of the main mask, this proximity being dictated by the optical conjugation of the lens with the reflector.

Finally, an elliptical headlamp is known from the document U.S. Pat. No. 5,339,226, comprising a left-hand mask and a right-hand mask, both mounted pivoting about an axis perpendicular to the optical axis of the headlamp. Each mask consists of two parts extending in planes which are perpendicular and integral with the same rotational shaft. The right-hand and left-hand masks are imbricated into one another so as to be able to combine the parts of the two masks in different ways so as to form beams with different cut-offs. Such a design of masks is relatively complex, resulting in high cost. Furthermore, this headlamp can only produce cut-off or dipped beams, and not a main beam.

### OBJECT OF THE INVENTION

The invention aims to remedy these drawbacks by proposing a headlamp equipped with movable masks which is simple and economical.

### DISCUSSION OF THE INVENTION

To that end, the invention proposes a headlamp of the type described above, wherein in that each mask is in the shape of a plate, especially a rectangular plate, including two substantially transverse and horizontal edges, and the axis of pivoting of each mask is arranged along one of its transverse edges.

According to other characteristics of the invention:

the axis of pivoting of at least one mask is arranged below the optical axis, and the transverse edge of the mask which is opposite to its axis of pivoting delimits its cut-off edge;

when a mask occupies its retracted position, it extends generally in a horizontal plane and, when a mask occupies its shading position, it extends generally in a vertical plane;

the axes of pivoting of the two masks are adjacent, the axis of the first mask being offset axially rearwards with respect to the axis of the second mask, when it occupies its retracted position, the first mask extends axially rearwards, while the second mask extends axially forwards, and, in order to pass from a retracted position to a shading position, the first mask pivots by about a quarter-turn forwards and upwards, while the second mask pivots by about a quarter-turn rearwards and upwards;

the axis of pivoting of at least one mask is arranged above the optical axis, and, in its shading position, the plate forming the mask comprises a shading lower part and an upper part including a window in order to allow the light beam to pass with a view to carrying out the associated lighting function, the window being delimited downwards by the substantially transverse upper edge of the shading part which forms the cut-off edge of the mask;

when the first mask is driven into retracted position and the second mask into shading position, a regulatory dipped-headlamp lighting beam is produced;

when the first mask is driven into shading position and the second mask into retracted position, an improved lighting beam is produced, such as a lighting beam for driving in wet weather or a lighting beam for driving in town or a lighting beam for driving on the motorway;

when the two masks are driven into retracted position, a regulatory main-headlamp lighting beam is produced;

when the two masks are driven into shading position, an improved lighting beam is produced;

the headlamp includes at least one additional mask for the purpose of carrying out at least one supplementary lighting function.

Other characteristics and advantages of the invention will become apparent on reading the detailed description which follows.

### BRIEF DESCRIPTION OF THE DRAWINGS

FIG. 1 is a sectional view which diagrammatically represents an elliptical headlamp produced in accordance with the teachings of the invention, in which a first mask occupies its shading position and a second mask occupies its retracted position;

FIG. 2 is a view similar to that of FIG. 1, which diagrammatically represents an embodiment variant of the invention in which the second mask has its pivoting axis arranged above the optical axis of the headlamp;

FIG. 3 is a view in perspective which diagrammatically represents the headlamp of FIG. 1 with the first mask in its shading position and the second mask in its retracted position;

FIG. 4 is a view similar to that of FIG. 3 which diagrammatically represents the headlamp of FIG. 1 with the first mask in its retracted position and the second mask in its shading position;

FIG. 5 is a view similar to that of FIG. 3 which diagrammatically represents the headlamp of FIG. 1 with the two masks in shading position;

FIG. 6 is a view similar to that of FIG. 3 which diagrammatically represents the headlamp of FIG. 1 with the two masks in retracted position.

### DESCRIPTION OF THE PREFERRED EMBODIMENTS OF THE INVENTION

It should be noted that, from one figure to another, the elements which are identical or similar are referenced as far as possible by the same reference marks.

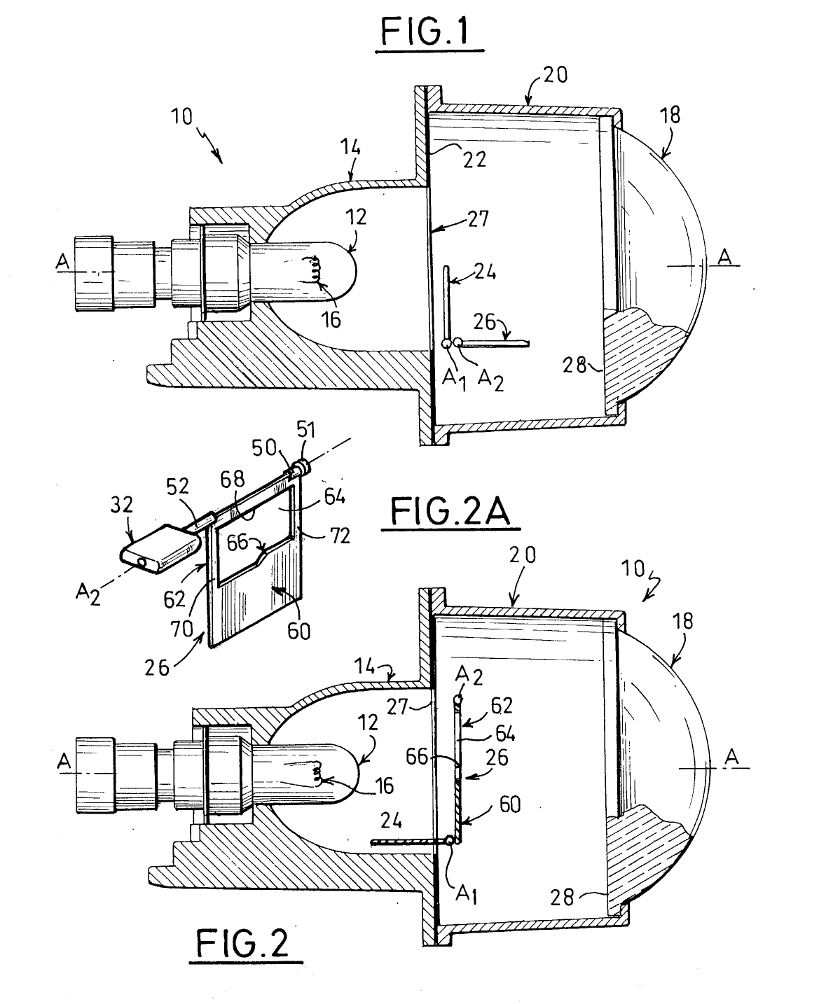

In FIG. 1, a headlamp 10 for a motor vehicle has been represented, including a lamp 12 mounted in the back of a reflector 14 of the elliptical type, such that the filament 16 of the lamp 12 lies in the vicinity of a first focus of the reflector 14.

In the rest of the description, a rear-to-front orientation will be used in a non-limiting way, along the optical axis A-A of the headlamp 10, which corresponds to a left-to-right orientation when considering FIG. 1. The optical axis A-A is generally parallel to the longitudinal axis of the vehicle which the headlamp 10 equips.

The optical axis A-A here is substantially horizontal, and it can be defined, for example, by the two foci of the reflector 14.

An orientation from top to bottom will also be used, in a non-limiting way, along a vertical axis, when considering FIG. 1.

A transverse direction is defined, which is substantially horizontal and orthogonal to the optical axis A-A.

The headlamp 10 includes a converging lens 18 which is mounted, at the front, in a framework part 20 of the headlamp 10 which is fixed onto a front transverse surface 22 of the reflector 14.

The focal plane of the lens 18 passes in the vicinity of the second focus of the reflector 14.

The headlamp 10 includes a first mask 24 and a second mask 26 which are interposed axially (A-A) between the reflector 14 and the lens 18, in the vicinity of the focal plane of the lens 18.

All the above-described elements constitute an optical unit of the headlamp 10 which is mounted, for example, conventionally, in a casing (not represented) closed off by glazing.

In accordance with the teachings of the invention, the first mask 24 and the second mask 26 are mounted so as to pivot with respect to the reflector 14, in each case about a transverse geometric axis, respectively a rear axis A1 and a front axis A2, between a retracted position Pe and a shading position Po.

In a variant, it could be provided for the two masks 24 and 26 to be mounted so as to pivot about the same axis.

The masks 24, 26 are mounted, for example, so as to pivot on an intermediate framework piece 27 which is interposed axially between the reflector 14 and the framework piece 20.

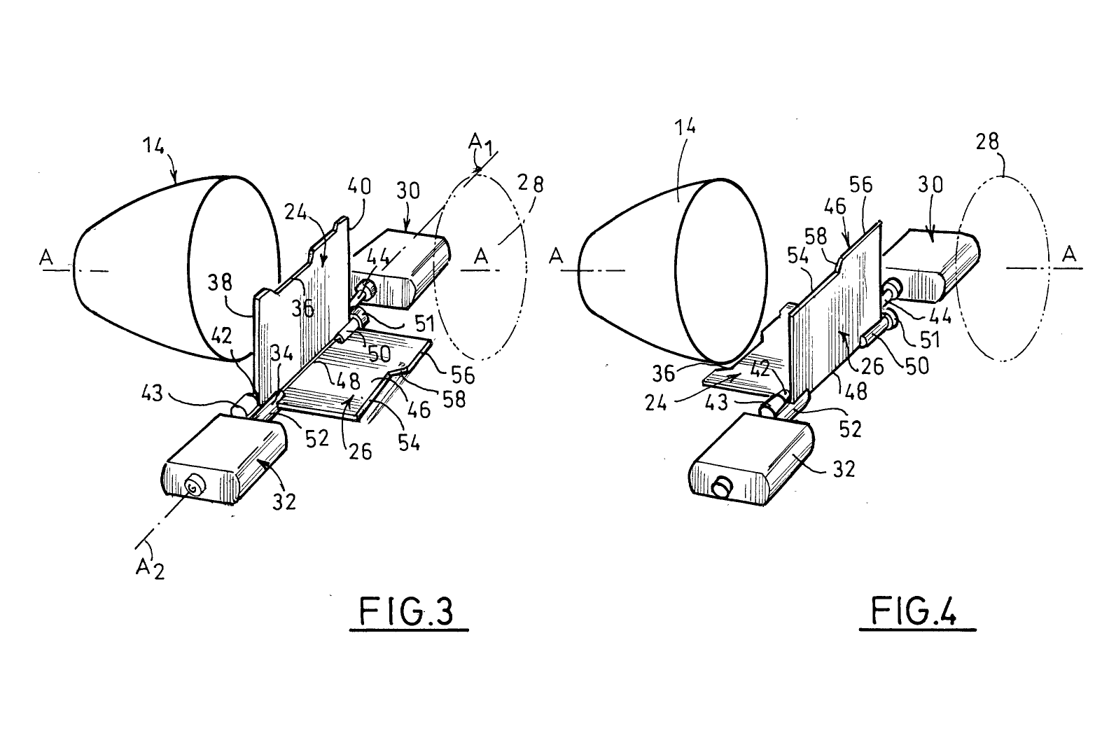

The headlamp 10 of FIG. 1 has been represented in a simplified way in FIG. 3. A portion of the reflector 14 and the two masks 24, 26 therefore appear on this figure.

The rear transverse face 28 of the lens 18 has also been represented, in a broken line.

Drive actuators of the masks 24, 26 have also been represented, here in the form of two electric motors 30, 32.

Needless to say, other types of drive actuators could be used, for example actuators with electromagets like those which are used for the pivoting of the asks in the document FR-A-2.796.449, to which reference could be made for further details.

Advantageously, the electric motors 30, 32 are controlled by an electronic drive unit (not represented).

In FIGS. 1 and 3, the first mask 24 is represented in shading position Po and the second mask 26 is represented in retracted position Pe.

In the embodiment represented here, each mask 24, 26 has the overall shape of a rectangular plate which, in the shading position Po, extends in a transverse and vertical plane, and which, in the retracted position Pe, extends in a horizontal plane.

Advantageously, the rectangular plates forming the masks 24, 26 have substantial dimensions which enhances their capacity for removing the heat and which allows them to be less sensitive to the thermal stresses within the headlamp 10.

The first mask 24 will now be described when it occupies its shading position Po.

The first mask 24 is in plate form, and includes two substantially transverse edges 34, 36 and, by way of non-limiting example here, two substantially vertical lateral edges 38, 40 which give the plate an overall rectangular shape.

The geometric axis of pivoting A1 of the first mask 24 is arranged here along the lower transverse edge, or pivoting transverse edge 34.

For its mounting so as to pivot, the first mask 24 includes, at each of the extremities of the pivoting transverse edge, a stub shaft 42, 44 which, on one side, is mounted free in rotation in a bearing 43 and, on the other side, is integral in rotation with the drive shaft of an electric motor 30.

The transverse edge 36 opposite the pivoting transverse edge 34 forms the cut-off edge of the mask 24, that is to say that it delimits a cut-off profile for the lighting beam given off by the headlamp 10 when the mask 24 occupies its shading position Po.

The cut-off edge 36 of the first mask 24 is designed, for example, to carry out a lighting function of the “AFS” type. Here it features a relief formed by several horizontal portions and by several inclined portions which can make it possible for it to carry out a lighting function of the “Adverse Weather Lighting” type, that is to say a lighting function for driving in wet weather which limits the dazzling caused towards vehicles driving in the opposite direction.

Needless to say, the cut-off edge 36 of the first mask 24 may be designed to carry out another type of lighting function, for example a lighting function for town driving or a lighting function for motorway driving.

In the embodiment represented here, the second mask 26 is similar to the first mask 24 and it is represented in its retracted position Pe in FIGS. 1 and 3.

The second mask 26 therefore includes a cut-off transverse edge 46 and a pivoting transverse edge 48 which, at one extremity, includes a stub shaft 50 mounted free to rotate in a bearing 51, and, at the opposite extremity, a stub shaft 52 which is linked in rotation to the drive shaft of a second electric motor 32.

It would also be possible to provide for the first mask 24 and/or the second mask 26 to be driven by the motors 30 and 32 by way of a gear train forming a rotational-speed reducer.

It would also be possible to provide for one and/or the other mask 24 and 26 to be integral with a toothed wheel meshing with a worm screw integral with the output shaft of the motors 30 and 32. Such an arrangement has the advantage of an irreversible movement transmission, and, correspondingly, that of ensuring a stable position for each mask, both in shading position as well as in retracted position.

The cut-off edge 46 of the second mask 26 is designed, for example, to carry out a lighting function as a dipped beam. It therefore includes two horizontal portions 54, 56, offset vertically, in the shading position Po, and linked by an inclined portion 58 such that the headlamp 10 produces a regulatory dipped-headlamp beam.

Advantageously, the cut-off edges 36, 46 of the two masks 24, 26 are designed so that, when the two masks 24, 26 occupy their shading position Po, the super-imposition of the masks 24, 26 along the optical axis A-A makes it possible to carry out a supplementary “AFS” lighting function.

It will be noted that this lighting function should include a lighting beam featuring a larger shaded portion than in each of the lighting functions associated with the two masks 24, 26, since the light beam associated with this supplementary lighting function will be shaded both by the first 24 and the second 26 masks.

This supplementary lighting function is, for example, a lighting function for driving in town, in which (“TownLighting”) the shading is more substantial than in the lighting for wet weather (“Adverse Weather Lighting”).

In the embodiment represented here, the two axes of pivoting A1, A2 are adjacent and contained in the same horizontal plane, moreover they are situated below the optical axis A-A.

It will be observed in FIG. 4 that, when it occupies its retracted position Pe, the first mask 24 extends axially (A-A) rearwards, while the second mask 26, in its retracted position Pe which is represented in FIG. 3, extends axially (A-A) forwards.

Consequently, in order to pass from a retracted position Pe to a shading position Po, the first mask 24 pivots by about a quarter-turn forwards and upwards, while the second mask 26 pivots by about a quarter-turn rearwards and upwards.

The operation of the headlamp 10 according to the invention will now be described, referring particularly to FIGS. 3 to 6.

When it is desired to produce a regulatory dipped-headlamp beam, then the corresponding mask is driven, here the second mask 26, into shading position Po and the first mask 24 is driven into retracted position Pe, which corresponds to the situation represented in FIG. 4.

From the situation represented in FIG. 4, if it is desired to produce a wet-weather lighting beam, then the second mask 26 is driven into its retracted position Pe, which causes it to pivot by a quarter-turn, in the clockwise direction when considering FIG. 1, and the first mask 24 is driven into its shading position Po, which causes it to pivot by a quarter-turn, in the clockwise direction when considering FIG. 1. This is then the situation which is represented in FIGS. 1 and 3.

In order to produce a regulatory main-headlamp beam, it is sufficient to drive the two masks 24, 26 into retracted position Pe, so as to let through the majority of the light rays given off by the lamp 12.

If it were the situation of FIG. 4 which applied, that is to say in the dipped-headlamp mode, then it is sufficient to drive the pivoting of the second mask 26 by a quarter-turn in the clockwise direction.

It will be noted that, in its retracted position Pe, the first mask 24 folds down towards the inside of the reflector 14, such that it covers over a lower portion of the reflecting concave surface of the reflector 14. This characteristic is not disadvantageous, since the area of the reflector 14 which it covers over in retracted position Pe has practically no optical function as regards the production of the lighting beam.

Hence, in their retracted positions Pe, the two masks 24, 26 are not on the path of the light rays producing the lighting beam, which makes it possible to obtain a main-headlamp beam featuring maximum brightness and thus an effective main-headlamp beam.

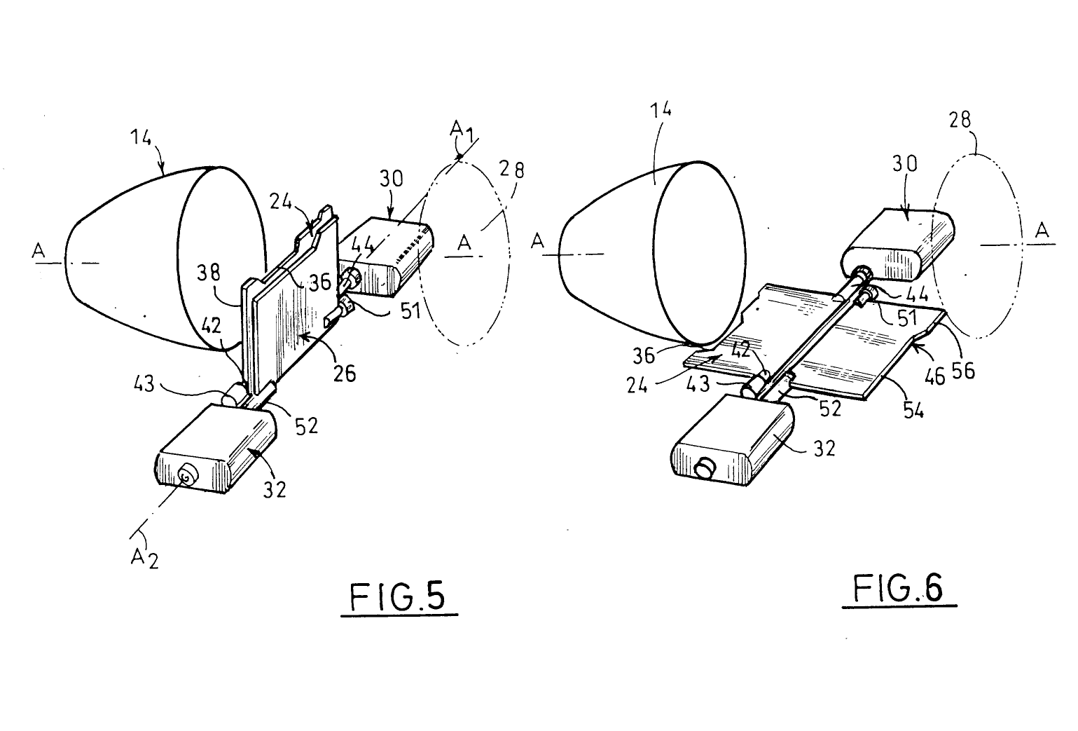

Advantageously, by simultaneously driving the two-masks 24, 26 into their shading position Po, as has been represented in FIG. 5, an improved lighting function is carried out, here a lighting beam for driving in town.

The shading effect produced by the two masks 24, 26 is superimposed and makes it possible to obtain a light beam featuring a specific cut-off profile, different from those obtained with only one of the masks 24, 26 in shading position Po.

It will be noted that, as the technique of pivoting a mask 24, 26 along a transverse axis is already applied in elliptical headlamps such as those described in the document FR-A-2.796.449, the industrial production of the headlamp 10 according to the invention is simple to implement. This technique of pivoting of the masks 24, 26 thus makes it possible to obtain a reliable and economical headlamp 10.

According to an embodiment variant which is represented in FIG. 2, at least one of the two masks 24, 26 can have its axis of pivoting A1, A2 arranged above the optical axis A-A.

In FIG. 2, the second mask 26 has been represented with its geometrical axis of pivoting A2 arranged above the optical axis A-A. In this figure, the second mask 26 has been represented in shading position Po and the first mask 24 in retracted position Pe.

According to this variant, when the second mask 26 occupies its shading position Po, the rectangular plate forming the second mask 26 comprises a shading lower part 60 and an upper part 62 including a window 64 for allowing the light beam to pass through with a view to carrying out the associated lighting function, here the dipped-headlamp function.

The window 64 is delimited downwards by the substantially transverse upper edge 66 of the shading part 60 which forms the cut-off edge of the mask.

The window 64 is delimited upwards by the pivoting upper transverse edge 68 of the mask 26, which, at one extremity, carries the stub shaft 50 mounted so as to rotate in the associated bearing 51, and, at the opposite extremity, the stub shaft 52 linked in rotation to the drive shaft of the associated motor 32.

The cut-off edge 66 and the pivoting edge 68 of the mask 26 are linked here by two vertical lateral uprights 70, 72.

The operation of the second mask 26 of this variant is similar to the operation described above, the main difference here being the direction of pivoting which is reversed.

In order to pass from its shading position Po, which is represented in FIG. 2, to its retracted position Pe, the second mask 26 pivots by a quarter-turn in the anti-clockwise direction.

According to another embodiment variant (not represented), the headlamp 10 may include a supplementary mask with a view to carrying out at least one supplementary lighting function.

This supplementary mask may, for example, be arranged with its axis of pivoting above the optical axis A-A, like the second mask of FIG. 2, the first mask 24 and the second mask 26 then being produced according to the embodiment described by reference to FIG. 1.

What is claimed is:

1. Headlamp for a motor vehicle, comprising a light source, a reflector of the elliptical type, a first focus of which is situated in the vicinity of the source, a converging lens a focal plane of which passes in the vicinity of a second focus of the reflector, a first and a second mask which are interposed axially, along the optical axis of the headlamp, between the reflector and the lens, of the kind in which the first mask is mounted pivoting about a substantially transverse axis between a retracted position and a shading position, the first mask including a cut-off edge which, in the shading position, delimits a cut-off profile of the light beam given off by the source with a view to carrying out a first lighting function, and of the kind in which the second mask is mounted movable between a protracted position and a shading position which makes it possible to carry out at least one second lighting function by modifying the cut-off profile of the light beam, the second mask being mounted for pivoting about a substantially transverse axis, and each of the two masks being able to be controlled and used independently in such a way that, depending on their relative position, at least three distinct lighting functions are carried out; wherein each mask is in the shape of a plate, more particularly a rectangular plate, including two substantially transverse and horizontal edges, and the pivoting axis of each mask is disposed along one of its transverse edges.

2. Headlamp according to claim 1, wherein the pivot axis of at least one mask is arranged below the optical axis, and the transverse edge of the mask which is opposite to its pivot axis delimits its cut-off edge.

3. Headlamp according to claim 1, wherein when a mask occupies its retracted position, it extends generally in a horizontal plane and, when a mask occupies its shading position, it extends generally in a vertical plane.

4. Headlamp according to claim 3, wherein the pivot axes of the two masks are adjacent, the axis of the first mask being offset axially rearwards with respect to the axis of the second mask; and wherein, when it occupies its retracted position, the first mask extends axially rearwards, while the second mask extends axially forwards, and in that, in order to pass from a retracted position to a shading position, the first mask pivots by substantially a quarter-turn forwards and upwards, while the second mask pivots by substantially a quarter-turn rearwards and upwards.

5. Headlamp according to claim 1, wherein the pivot axis of at least one mask is arranged above the optical axis, and in its shading position, the plate forming the mask comprises a shading lower part and an upper part including a window in order to allow the light beam to pass with a view to carrying out the associated lighting function, the window being delimited downwards by the substantially transverse upper edge of the shading part which forms the cut-off edge of the mask

6. Headlamp according to claim 1, wherein when the first mask is driven into a retracted position and the second mask into a shading position, a regulatory dipped-headlamp lighting beam is produced; and wherein when the first mask is driven into a shading position and the second mask into a retracted position, an improved lighting beam is produced, for example a lighting beam for driving in wet weather or a lighting beam for driving in town or a lighting beam for driving on the motorway; and wherein when the two masks are driven into a retracted position, a regulatory main-headlamp lighting beam is produced; and when the two masks are driven into a shading position, an improved lighting beam is produced.

7. Headlamp according to claim 1, including at least one additional mask for the purpose of carrying out at least one supplementary lighting function.
